(19) United States
(12) Patent Application Publication
(10) Pub. No.: US 2014/0358628 A1
(43) Pub. Date: Dec. 4, 2014

(54) METHOD AND APPARATUS FOR EVALUATING INTERRELATIONSHIPS AMONG BUSINESS DRIVERS

(71) Applicant: ROLLS-ROYCE PLC, London (GB)

(72) Inventor: Umayal PALANIAPPAN, Derby (GB)

(21) Appl. No.: 13/907,160

(22) Filed: May 31, 2013

(51) Int. Cl. G06Q 10/06

(52) U.S. Cl. CPC G06Q 10/06375
USPC 705/7.29

(57) ABSTRACT

An apparatus configured to evaluate influence interrelationships among a plurality of business drivers generates an interrelationship matrix that quantifies the influence interrelationships among the plurality of business drivers, ranks the quantified influence interrelationships included in the interrelationship matrix to yield influence rankings, sums the influence rankings, ranks the plurality of business drivers based on the summed influence rankings to yield business driver rankings, and outputs the business driver rankings.

### BACKGROUND

1. Related Technical Fields

Related technical fields include methods, systems, and programs for evaluating interrelationships among selected business drivers and for presenting the results of such an evaluation in a usable format.

2. Related Art

The business driver model has become an effective tool for gauging the operational success of a business and for forecasting the influence upon the business of adjustments in the programs comprising a portfolio. For example, as shown in FIG. 1, current levels of business drivers BD1-BD4 are illustrated via filled-in bars. Target levels of business drivers BD1-BD4 are illustrated via dashed bars. To attempt to narrow the gaps between current and target levels, it has previously been known to analyze first-degree influences between business drivers and the programs of the portfolio that influence these business drivers. That is, it has previously been known to predict the change an adjustment in a program will have upon a particular business driver and adjust the program based upon this prediction in the effort to reach the target level for the particular driver.

### SUMMARY

Business drivers are, according to one definition, the main factors and resources that provide the essential marketing, sales, and operational functions of a business. Stated another way, business drivers are the operational elements that have a significant impact upon the overall success and profitability of a particular business, and they often vary from industry to industry. Examples of business drivers include Sales per Unit of Area in the retail industry, Machine Downtime in manufacturing, Quality of Technical Support in the electronics and software industries, and the Number of Advertisements sold in the publishing industry.

Business drivers are influenced by the various transformational programs and projects comprising a portfolio. For example, in the manufacturing industry, Machine Downtime is influenced by the frequency of inspections of the machines and the thoroughness and quality of repairs to the machines. Similarly, in the electronics and software industries, Quality of Technical Support is influenced by the amount of training provided to support personnel and the number of support personnel employed.

As discussed previously, it is known to analyze first-degree influences between business drivers and the programs of the portfolio that influence them. However, merely considering first-degree influences between programs and business drivers yields incomplete information and therefore often fails to accurately predict changes in business drivers. To correct this deficiency, it becomes necessary to also consider second-degree influences—those resulting from the various interrelationships among the business drivers themselves. More specifically, to accurately forecast the total influence an adjustment in a particular program will have upon various business drivers, it also becomes necessary to consider the influence a change in one business driver has upon another driver.

Accordingly, to effectively evaluate the influence interrelationships among a plurality a business drivers, various exemplary embodiments of the broad inventive principles described herein rank the individual drivers of the plurality of business drivers according to various criteria. For example, various exemplary embodiments of the method and system disclosed in this application evaluate a particular driver of the plurality of business drivers based upon how it is influenced by changes in other business drivers and based upon how changes in the particular driver influence the other business drivers.

To conduct such evaluations, various exemplary embodiments of the method and system disclosed in this application generate an interrelationship matrix quantifying the influence interrelationships among the plurality of business drivers. Various exemplary embodiments rank the quantified influence interrelationships included in the interrelationship matrix to yield influence rankings. Various exemplary embodiments sum the influence rankings. And various exemplary embodiments rank the plurality of business drivers based on the calculated sums.

### BRIEF DESCRIPTION OF THE DRAWINGS

FIG. 1 shows an exemplary analysis in which gaps exist between business driver starting levels and business driver target levels.

FIG. 2 shows a flowchart outlining an exemplary algorithm of the business driver evaluation method disclosed in this application.

FIG. 3 shows a flowchart outlining an exemplary algorithm of the baseline data creation Step S10.

FIG. 4 shows an exemplary embodiment of the interrelationship matrix disclosed in this application that is appropriate for the aircraft manufacturing industry.

FIG. 5 shows a flowchart outlining an exemplary algorithm of the business driver ranking Step S30.

FIG. 6 shows an exemplary embodiment of the magnitude ranking matrix disclosed in this application that is derived from the interrelationship matrix of FIG. 4.

FIGS. 7A and 7B respectively show exemplary rankings, derived from the magnitude ranking matrix of FIG. 6, of business drivers from Most Dominant to Least Dominant and from Least Influenced to Most Influenced.

FIG. 8 shows an exemplary ranking of business drivers from Most Dominant/Least Influenced to Least Dominant/Most Influenced that is derived from the rankings of FIGS. 7A and 7B.

FIG. 9 shows a functional block diagram of an exemplary embodiment of a business driver evaluation system.

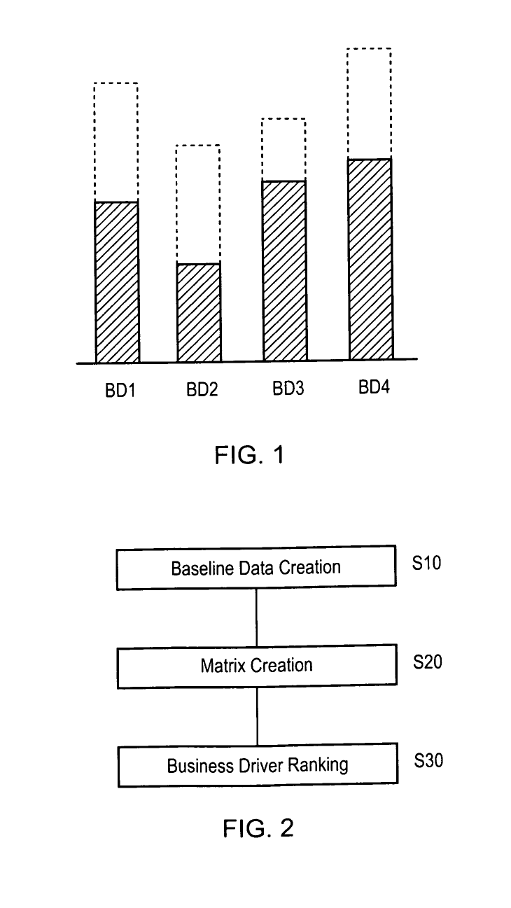

### DETAILED DESCRIPTION OF THE EMBODIMENTS

FIG. 2 shows a higher-level flowchart outlining an exemplary embodiment of the business driver evaluation method disclosed in this application. Steps S10 and S30 comprising the higher-level flowchart will be described in greater detail in the description below and in the corresponding Figures. As shown in FIG. 2, the operation of the method begins in Step S10, where baseline data is created for selected business drivers. Thereafter, in Step S20, an interrelationship matrix quantifying the influence interrelationships among the selected business drivers is created from the baseline data. Finally, in Step S30, each selected business driver is ranked based on its influence upon other business drivers and on the influence other business drivers have upon it. The created baseline data and the interrelationship matrix will be described below as part of the description relating to Steps S10 and S20.

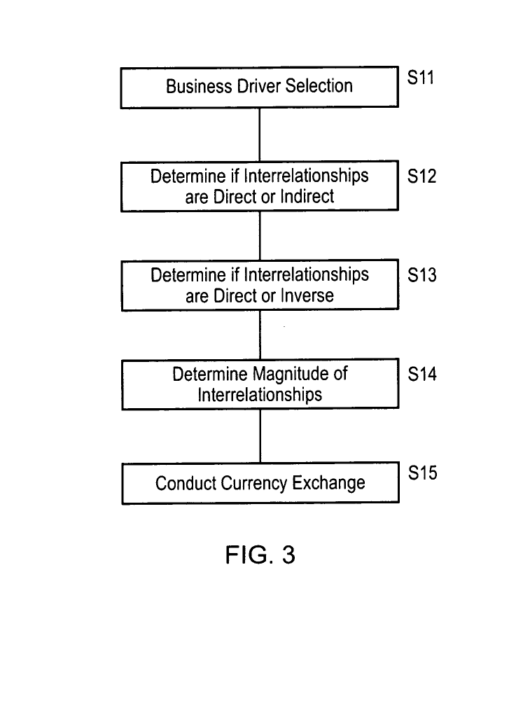

FIG. 3 shows a flowchart outlining an exemplary embodiment of the baseline data creation Step S10.

In Step S11, business drivers are selected and their metrics are defined. This process can be done by either an agent-based system, manually by individuals, or by any combination of both. Metrics are an assigned currency or value for a specific business driver. For example, the metric for speed is kilometers per hour. As such, any business driver may have a metric assigned to clearly articulate the baseline data that will represent its currency and value. An agent-based system is any manual or automated depository of information that collects data over time for the business metrics. For example, agent-based systems can be simple, complex, or intelligent software-based systems that contain historical data for the metric. Individual agents can synchronize multiple conversations into the specific business drivers and metrics.

Business drivers can be chosen by the business at an executive level. As previously discussed, business drivers are the main factors and resources that provide the essential marketing, sales, and operational functions of a business, and they differ from industry to industry. In other words, business drivers represent the fundamental essence of a business's intent, its key characteristics, and they relate to the ultimate profit of the business. For example, in the software development industry, business drivers may include Quality Customer Service, Rapid Delivery of Projects, Solid Technical Support, and Product Quality. However, in the exemplary embodiment, being specifically directed to the aircraft manufacturing industry, business drivers can be as follows: Airline Disruption, Return on Sales, Simple & Scalable, Employee Engagement, Customer Responsiveness, Engine Availability, Customer Satisfaction, Journey to Process Excellence, and Risk Mitigation/Business Continuity.

As also discussed previously, each business driver is influenced by various transformative programs comprising a portfolio. For example, in the software development industry, Solid Technical Support is influenced by the amount of training provided to support personnel and the number of support personnel employed. Similarly, in the exemplary embodiment, Engine Availability is influenced by the extent of maintenance provided to existing engines and the rapidity at which new engines are produced.

Once the business drivers and their metrics have been defined, the various influence interrelationships among the selected business drivers are determined in Steps S12-S14. These influence interrelationships can be determined by relying on historical data (over a period of the previous three years for example), by relying on the knowledge of subject matter experts, or by utilizing any permissible combination of both. In Step S12, it is determined whether the influence interrelationships among the selected business drivers are direct or indirect. As an example of the determination conducted during Step S12, suppose three business drivers have been selected: A, B, and C. If business driver A only influences business driver C by first influencing business driver B, which in turn influences business driver C, the interrelationship between business drivers A and C is determined to be indirect. However, if business driver A influences business driver C without the necessity of first influencing business driver B, such an interrelationship between business drivers A and C is determined to be direct. In Step S13, it is determined whether these interrelationships are direct or inverse. That is, it is determined in Step S13 whether an increase in a particular business driver results in an increase (direct) or a decrease (inverse) in another business driver. Similarly, it is determined in Step S13 whether a decrease in a particular business driver results in a decrease (direct) or an increase (indirect) in another business driver. Thereafter, in Step S14, the magnitudes of the influence interrelationships among the selected business drivers are determined. Stated another way, it is determined in Step S14 the size of the change an adjustment in one business driver has upon another business driver.

Finally, in Step S15, because the metrics or units used to measure the business drivers may, in certain applications, differ from driver to driver, currency exchange may be conducted. During this currency exchange, the influence magnitudes among the business drivers determined in Step S14 are convened to percentage values so as to allow direct comparison among the selected business drivers despite their potential differences in metrics.

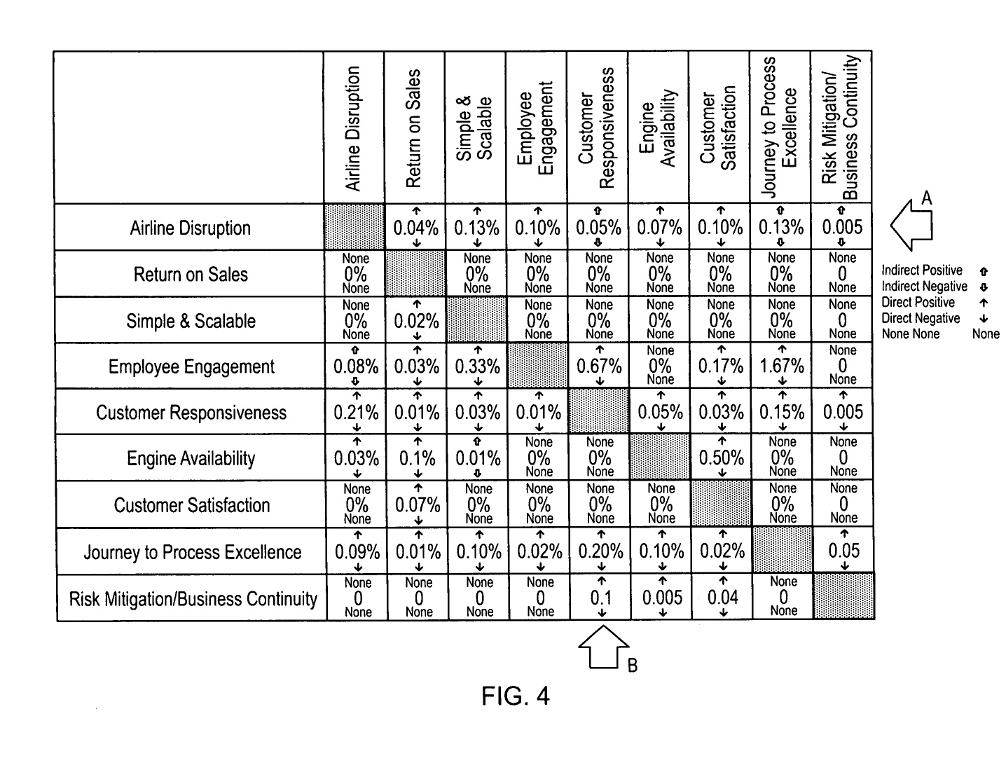

Returning to FIG. 2, an interrelationship matrix is generated in Step S20 that utilizes the baseline data created in Step S10. An exemplary embodiment of this interrelationship matrix, appropriate for the aircraft manufacturing industry, is shown in FIG. 4. In the exemplary embodiment, the selected business drivers are provided. For example, the exemplary embodiment being appropriate for the aircraft manufacturing industry, business drivers Airline Disruption, Return on Sales, Simple & Scalable, Employee Engagement, Customer Responsiveness, Engine Availability, Customer Satisfaction, Journey to Process Excellence, and Risk Mitigation/Business Continuity are provided. These drivers, for example, may be sequentially arranged along both the leftmost column and the uppermost row of the interrelationship matrix. As definitions of some of these drivers, Journey to Process Excellence may represent the maturity of the business in its processes, the enabling behaviors, and the applicable Lean Six Sigma maturity levels. Employee Engagement may be a survey-based scoring to determine the health and morale of the employees within the company. Risk Mitigation and Business Continuity may be a scored ranking that represents the readiness and maturity of risks within the business based on a set criteria matrix for the company.

Additionally, quantified influence interrelationships between the above-listed business drivers may be provided. For example, the percentage value in each cell of the interrelationship matrix in FIG. 4 indicates the magnitude of the influence a 1% change in the business driver provided in the corresponding leftmost column has upon the business driver provided in the corresponding uppermost row. Thus, with reference to the cell indicated by arrow “A,” a 1% change in Airline Disruption results in a 0.005% change in Risk Mitigation/Business Continuity. Similarly, with reference to the cell indicated by arrow “B,” a 1% change in Risk Management/Business Continuity results in a 0.1% change in Customer Responsiveness. Although the exemplary embodiment presents influence magnitudes based upon a corresponding 1% change in a business driver, virtually any other value of the change in the business driver may be used.

With further reference to FIG. 4, the exemplary embodiment may also indicate the directionality of the influence interrelationships among the selected business drivers. For example, a positive influence may be indicated as an arrow above the magnitude in each cell, and a negative influence may be indicated as an arrow below the magnitude in each cell. Additionally, an additional indication of whether an influence interrelationship is positive or negative may be provided. For example, the displayed color of the arrow may differ depending on whether the influence is positive or negative. More specifically, the arrow may be green if the influence is positive and may be red if the influence is negative. Furthermore, the exemplary embodiment may also indicate whether an influence interrelationship between two business drivers is direct or indirect. For example, the interrelationship matrix may display such information by virtue of the type of arrow indicated. As an example, the cell indicated by arrow “A” includes hollow arrows, thereby indicating that the influence interrelationship between Airline Disruption and Risk Mitigation/Business Continuity is indirect. Conversely, the cell indicated by arrow “B” includes filled arrows, thus indicating that the interrelationship between Risk Mitigation/Business Continuity and Customer Responsiveness is direct. Accordingly, the exemplary embodiment may simultaneously indicate the magnitude and the directionality of the various influences the selected business drivers have upon one another.

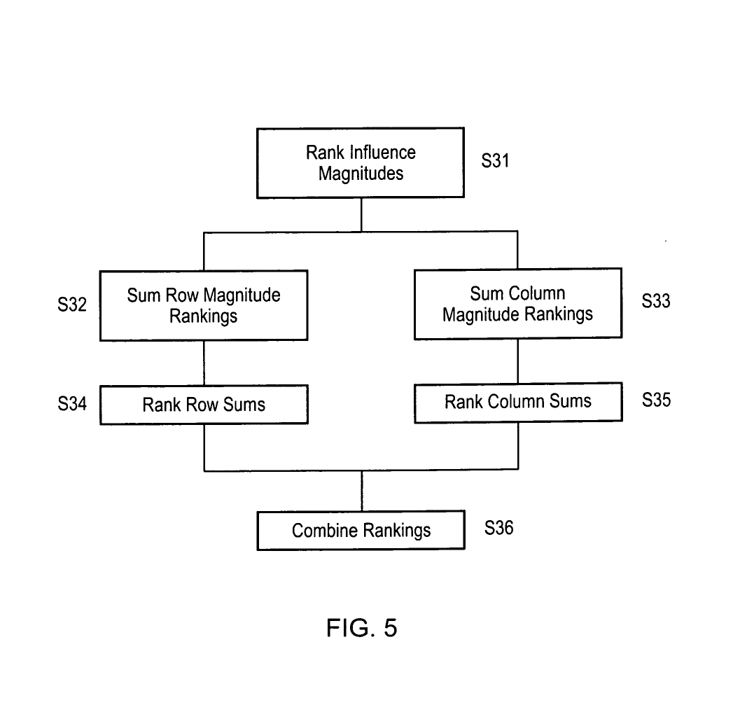

Returning once again to FIG. 2, the selected business drivers are ranked in Step S30 based upon the quantified influence interrelationships included in the interrelationship matrix created in Step S20. FIG. 5 shows a flowchart outlining an exemplary embodiment of the business driver ranking Step S30.

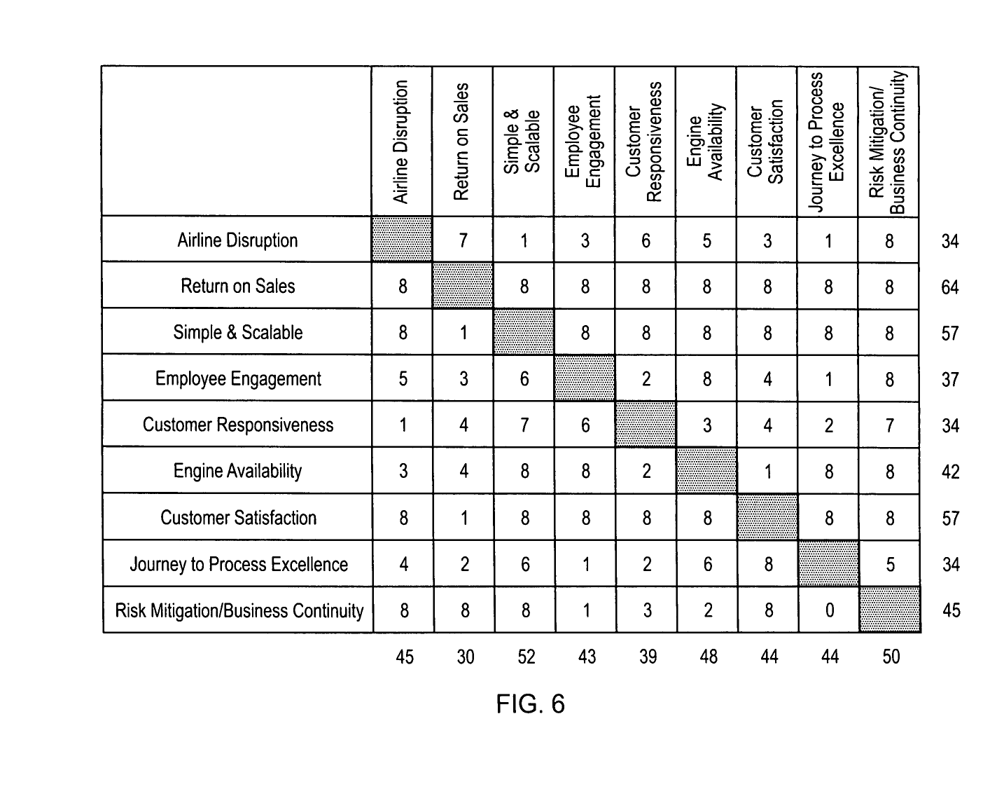

In Step S31, the magnitudes of the cells in the interrelationship matrix generated in Step S20 are ranked from highest to lowest. Thus, for example, the cell displaying the greatest magnitude in each row is labeled “1,” and the cell possessing the lowest magnitude in each row is labeled “8.” More specifically, with reference to the row in FIG. 4 corresponding to Airline Disruption, the cell corresponding to Airline Disruption and Simple & Scalable and the cell corresponding to Airline Disruption and Journey to Process Excellence, each indicating a magnitude of 0.13%, are ranked “1.” Conversely, the cell corresponding to Airline Disruption and Risk Mitigation/Business Continuity, indicating a magnitude of 0.005%, is ranked “8.” This ranking indicates that Airline Disruption has the greatest influence upon Simple & Scalable and Journey to Process Excellence and the least influence upon Risk Management/Business Continuity. The results of Step S31 are compiled in a magnitude ranking matrix. An exemplary embodiment of this magnitude ranking matrix, corresponding to the influence matrix shown in FIG. 4, is provided in FIG. 6.

Thereafter, in Step S32, the magnitude rankings in each row of the magnitude ranking matrix shown in FIG. 6 are summed. For example, in the row corresponding to Airline Disruption, the magnitude rankings sum to 34. Similarly, in the row corresponding to Risk Mitigation/Business Continuity, the magnitude rankings sum to 46. Simultaneously, in Step S33, the rankings in each column of the magnitude ranking matrix in FIG. 6 are summed. For example, in the column corresponding to Airline Disruption, the magnitude rankings sum to 45. Similarly, in the column corresponding to Risk Mitigation/Business Continuity, the magnitude rankings sum to 60. The results of Steps S32 and S33 for all columns and rows are also displayed in the magnitude ranking matrix shown in FIG. 6.

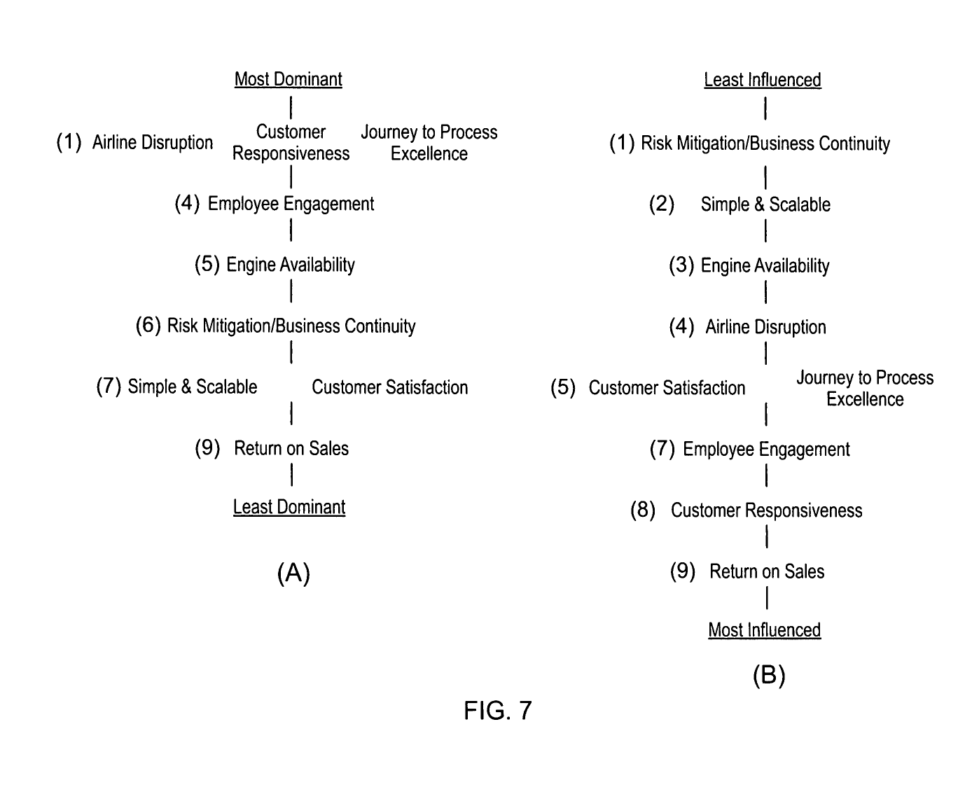

Next, in Step S34, the sums calculated in Step S32 for each row are ranked from lowest to highest. For example, because the row corresponding to Airline Disruption yields a lower sum than the row corresponding to Risk Mitigation/Business Continuity, the row corresponding to Airline Disruption is provided with a higher ranking (1) than the row corresponding to Risk Mitigation/Business Continuity (6). The ranking in Step S34 indicates which of the selected business drivers are more dominant and which are less dominant. That is, for which business driver does a specified change have the most influence upon the other business drivers. A higher ranking indicates that a business driver is more dominant and thus has a greater influence upon other drivers, and a lower ranking indicates that a business driver is less dominant and accordingly has a lesser influence upon the other drivers. Simultaneously, in Step S35, the sums derived in Step S33 for each column are ranked from highest to lowest. For example, because the column corresponding to Risk Mitigation/Business Continuity yields a higher sum than the column corresponding to Airline Disruption, the column corresponding to Risk Mitigation/Business Continuity is provided with a higher ranking (1) than the column corresponding to Airline Disruption (4). The ranking in Step S35 indicates which of the selected business drivers are less influenced by changes in other business drivers, a higher ranking indicating that a particular business driver is less changed by adjustments in other business drivers than a business driver possessing a lower ranking. The results of Steps S34 and S35 are illustrated in FIGS. 7A and 7B.

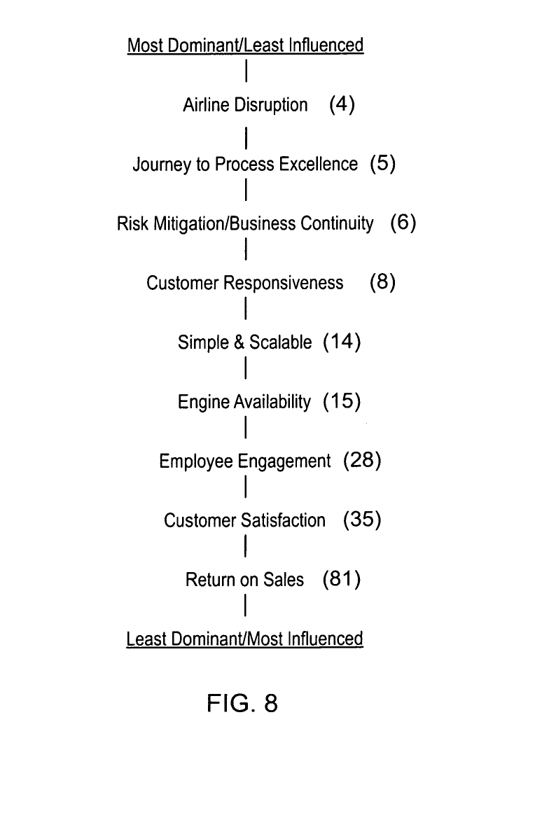

In Step S36, the results of Steps S34 and S35 are combined to yield a ranking of the selected business drivers from Most Dominant/Least Influenced to Least Dominant/Most Influenced. For example, in the exemplary embodiment, the ranking of a particular business driver derived in Step S34 is multiplied by the ranking of the particular business driver derived in Step S35. More specifically, ranking number “1” was given to Airline Disruption in Step S34 and ranking number “4” was given to Airline Disruption in Step S35, thereby yielding a product of 4. Similarly, ranking number “6” was given to Risk Management/Business Continuity in Step S34 and ranking number “1” was given to Risk Management/Business Continuity in Step S35, thus yielding a product of 6. Accordingly, in Step S36, Airline Disruption is ranked above Risk Management/Business Continuity. The results of Step S36 for the exemplary embodiment are shown in FIG. 8.

By virtue of the above-disclosed method that considers both the magnitude and the directionality of the interrelationships among selected business drivers, second-degree interrelationships among these business drivers may be effectively evaluated. By doing so, at least three tangible benefits are gained. First, adverse results originating from inversely-related business drivers may be defined and minimized, thereby allowing maximization of business driver levels across an entire portfolio. Second, the consideration of second-degree interrelationships allows the gap between target and current business driver levels to be more accurately predicted. As discussed previously, this gap provides a clear indication of the potential of the existing portfolio of projects or programs that are currently being run to deliver benefit to the business drivers. In other words, the gap flags the need of either additional programs, prioritization of a program, or redesigning the program entirely so that is delivers greater benefits. Finally, by considering second-degree interrelationships in the above-described manner, a manager is made plainly aware of which drivers have the largest influence or impact upon a business, thereby allowing the more efficient allocation of finite resources to achieve business objectives.

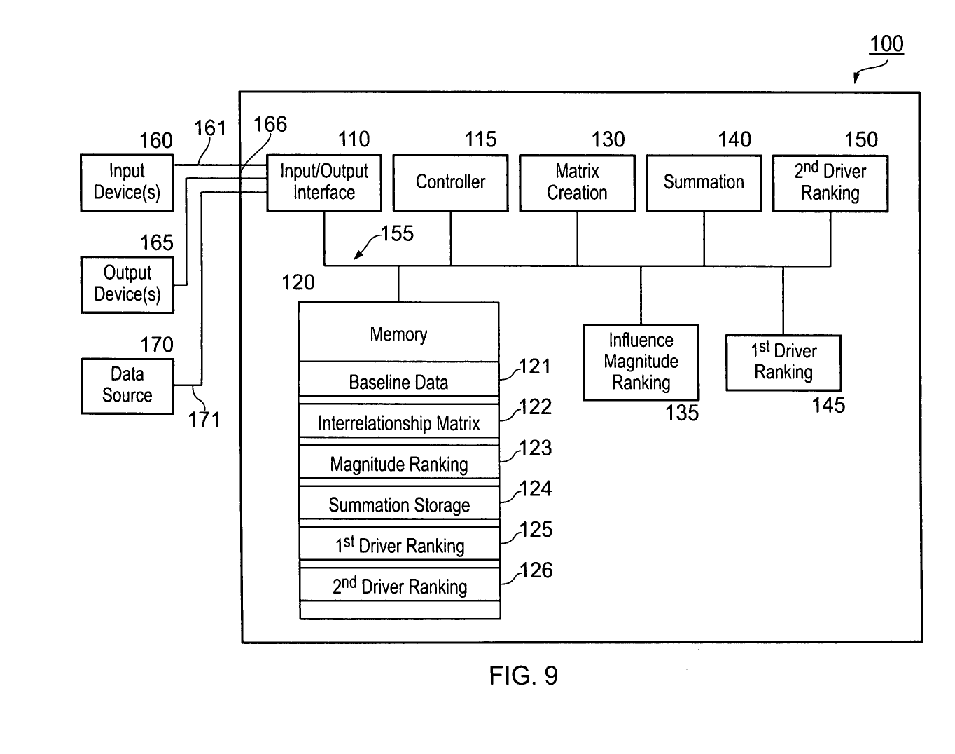

FIG. 9 shows a functional block diagram of an exemplary embodiment of a business driver evaluation system 100 that is usable to perform the process disclosed in this application. As shown in FIG. 9, the business driver evaluation system 100 physically, functionally, and/or conceptually includes an input/output interface 110, a controller 115, a memory 120, a matrix creation circuit, routine, or application 130, an influence magnitude ranking circuit, routine, or application 135, a summation circuit, routine, or application 140, a first driver ranking circuit, routine, or application 145, and a second driver ranking circuit, routine, or application 150, each appropriately connected by one or more data/control busses and/or application programming interfaces 155, or the like.

In the exemplary embodiment, the input/output interface 110 is connected to one or more input devices 160 over one or more links 161. The input device(s) 160 can be one or more of a keyboard, a mouse, a trackball, a touch screen, a virtual reality glove, or any known or later-developed device for inputting data and/or control signals to the business driver evaluation system 100. Furthermore, in the exemplary embodiment, the input/output interface 110 is connected to one or more output devices 165 over one or more links 166. The output device(s) can be one or more of a computer monitor, cathode ray tube, liquid crystal display, image projector, electrophoretic display, a virtual reality device, or any other known or later-developed device for visually displaying the data output from the business driver evaluation system 100.

In the exemplary embodiment, the input/output interface 110 is further connected to a data source 170 over a link 171. The data source 170 can be a locally or remotely located laptop or personal computer, a personal digital assistant, a tablet computer, a device that stores and/or transmits electronic data, such as a client or a server of a wired or wireless network, such as for example, an intranet, an extranet, a local area network, a wide area network, a storage area network, the Internet (especially the World Wide Web), and the like. In general, the data source 170 can be any known or later-developed source that is capable of providing necessary data to the input/output interface 110.

Each of the various links 161, 166, 171 can be any known or later-developed device or system for connecting the input device(s) 160, the output device(s) 165, and/or the data source 170, respectively, to the input/output interface 110. In particular, the links 161, 166, and 171 can each be implemented as one or more of a direct cable connection, a connection over a wide area network, a local area network or a storage area network, a connection over an intranet, a connection over an extranet, a connection over the Internet, a connection over any other distributed processing network or system, and/or an infrared, radio-frequency or other wireless connection.

Turning to the components of the business driver evaluation system 100 itself, the controller 115 can be a CPU, an MPU (optionally including a RAM and/or ROM), or any known or later-developed processor, circuit, or device for executing programs and instructions so as to operate the business driver evaluation system 100.

As shown in FIG. 9, the memory 120 contains a number of different memory portions, including a baseline data storage portion 121, an interrelationship matrix storage portion 122, a magnitude ranking storage portion 123, a summation storage portion 124, a first driver ranking storage portion 125, and a second driver ranking storage portion 126. The baseline data storage portion 121 of the memory 120 stores the baseline data indicating the various influence interrelationships among the selected business drivers. The interrelationship matrix storage portion 122 of the memory 120 stores the interrelationship matrix derived from the baseline data that presents the quantified influence interrelationships among the selected business drivers. The magnitude ranking storage portion 123 of the memory 120 stores the relative rankings of the magnitudes of these various quantified influence interrelationships. The summation storage portion 124 of the memory 120 stores the horizontal and vertical sums of the magnitude rankings for each business driver. Furthermore, the first driver ranking storage portion 125 of the memory 120 stores the rankings of the selected business drivers from Least Influenced to Most Influenced and from Most Dominant to Least Dominant. Finally, the second driver ranking storage portion 126 of the memory 120 stores the ranking of the selected business drivers from Most Dominant/Least Influenced to Least Dominant/Most Influenced.

The memory 120 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writeable or rewriteable optical disk and disk drive, a hard drive, flash memory, or the like. Similarly, the non-alterable or fixed memory can be implemented using any one or more of ROM, PROM, EPROM, EEPROM, an optical ROM disk, such as CD-ROM or DVD-ROM disk and disk drive, or the like.

The disclosed circuits, routines, or applications can be dedicated circuits and/or individual programs and/or routines in a larger program stored in a RAM, ROM, etc. and executed by the controller 115. Thus, in exemplary embodiments, the disclosed circuits, routines, or applications can be implemented by one or more programs executed by the controller 115.

The matrix creation circuit, routine, or application 130 accesses the baseline data and generates the interrelationship matrix. The influence magnitude ranking circuit, routine, or application 135 ranks the magnitudes of the quantified influence interrelationships contained within the interrelationship matrix. The summation circuit, routine, or application 140 sums the calculated magnitude rankings. Finally, the first and second driver ranking circuits, routines, or applications 145 and 150 rank the plurality of selected business drivers according to the calculated sums.

In operation, the exemplary embodiment of the business driver evaluation system 100 shown in FIG. 9 operates in the following manner. Under control of the controller 115, the baseline data indicating the various interrelationships among the selected business drivers is input from the data source 170 across the link 171 via the input/output interface 110 and stored in the baseline data storage portion 121 of the memory 120. Next, under control of the controller 115, the matrix creation circuit, routine, or application 130 accesses the baseline data in the baseline data storage portion 121 of the memory 120, generates an interrelationship matrix, such as that discussed above with respect to FIG. 4, that presents the quantified influence interrelationships among the selected business drivers, and stores the generated interrelationship matrix in the interrelationship matrix storage portion 122 of the memory 120.

Thereafter, under the control of the controller 115, the influence magnitude ranking circuit, routine, or application 135 accesses the interrelationship matrix storage portion 122 of the memory 120 and ranks the magnitudes of the quantified influence interrelationships contained within the interrelationship matrix with respect to each row of the interrelationship matrix. The influence magnitude ranking circuit, routine, or application 135 thereby creates the magnitude ranking matrix and, under the control of the controller 115, subsequently stores the magnitude ranking matrix in the magnitude ranking storage portion 123 of the memory 120. Next, under the control of the controller 115, the summation circuit, routine, or application 140 accesses the magnitude ranking matrix stored in the magnitude ranking storage portion 123 of the memory 120 and sums the magnitude rankings along each row and column of the magnitude ranking matrix, each row and column respectively corresponding to a single driver of the selected business drivers. Then, under the control of the controller 115, the summation circuit, routine, or application 140 stores the calculated sums in the summation storage portion 124 of the memory 120.

Under the control of the controller 115, the first driver ranking circuit, routine, or application 145 accesses the summation storage portion 124 of the memory 120 and ranks the calculated sums, thereby generating (1) a ranking of business drivers from Most Dominant to Least Dominant and (2) a ranking of business drivers from Least Influenced to Most Influenced. These rankings are, under the control of the controller 115, stored by the first driver ranking circuit, routine, or application 145 in the first driver ranking storage portion 125 of the memory 120. Finally, under the control of the controller 115, the second driver ranking circuit, routine, or application 150 accesses the first driver ranking storage portion 125 of the memory 120 and combines the ranking of business drivers from Most Dominant to Least Dominant and the ranking of business drivers from Least Influenced to Most Influenced to generate a single ranking of business drivers from Most Dominant/Least Influenced to Least Dominant/Most Influenced. The second driver ranking circuit, routine, or application 150, under the control of the controller 115S, stores the generated ranking of business drivers from Most Dominant/Least Influenced to Least Dominant/Most Influenced in the second driver ranking storage portion 126 of the memory 120. At this point, the ranking of the selected business drivers from Most Dominant/Least Influenced to Least Dominant/Most Influenced has been created and, under the control of the controller 115, is ready to be output to the output device(s) 165 across the link 166 via the input/output interface 110.

According to the above-described exemplary embodiments of the system and method, a ranking of selected business drivers from Most Dominant/Least Influenced to Least Dominant/Most Influenced is ultimately provided. As discussed previously, the results of the system and method allow adverse results originating from inversely-related business drivers to be defined and minimized, allow more accurate prediction of the gap between target and current business driver levels, and allow a manager to be made plainly aware of which drivers have the largest influence or impact upon a business, thereby allowing the more efficient allocation of finite resources to achieve business objectives.

While the invention has been described in conjunction with exemplary embodiments, these embodiments should be viewed as illustrative, not limiting. Various modifications, substitutions, or the like are possible within the spirit and scope of the invention.

What is claimed is:

1. An apparatus configured to evaluate influence interrelationships among a plurality of business drivers, each influence interrelationship indicating a change in one driver of the plurality of business drivers resulting from a change in another driver of the plurality of business drivers, the apparatus comprising:
a controller specifically configured to:
generate an interrelationship matrix that quantifies the influence interrelationships among the plurality of business drivers;
rank the quantified influence interrelationships included in the interrelationship matrix to yield influence rankings;
sum the influence rankings;
rank the plurality of business drivers based on the summed influence rankings to yield business driver rankings; and
output the business driver rankings.

2. The apparatus of claim 1, wherein the interrelationship matrix indicates:
a magnitude of each of the quantified influence interrelationships; and
a directionality of each of the quantified influence interrelationships, the directionality indicating whether the each quantified influence interrelationship is positive or negative.

3. The apparatus of claim 2, wherein the interrelationship matrix further indicates whether each quantified influence interrelationship is direct or indirect.

4. The apparatus of claim 2, wherein the interrelationship matrix indicates the magnitude of each of the quantified influence interrelationships as a percentage value.

5. The apparatus of claim 4, wherein the interrelationship matrix indicates that the directionality is positive by an arrow positioned above the percentage value and that the directionality is negative by an arrow positioned below the percentage value.

6. The apparatus of claim 5, wherein the arrow positioned above the magnitude and the arrow positioned below the magnitude are different colors.

7. The apparatus of claim 2, wherein the controller ranks the magnitudes of the quantified influence interrelationships.

8. The apparatus of claim 7, wherein the controller generates a magnitude ranking matrix.

9. The apparatus of claim 1, wherein:
the interrelationship matrix includes a plurality of columns and a plurality of rows, each column and row corresponding to a business driver of the plurality of business drivers,
each column and row includes a plurality of the quantified influence interrelationships, and
the controller ranks the plurality of the quantified influence interrelationships within each row with respect to the plurality of the quantified influence interrelationships comprising the each row.

10. The apparatus of claim 9, wherein the controller sums the rankings calculated by the influence ranking unit along each row and column of the plurality of columns and rows of the interrelationship matrix to yield a set of column sums and a set of row sums.

11. The apparatus of claim 10, wherein:
the controller ranks the set of column sums to generate a ranking of the plurality of business drivers from Least Influenced to Most Influenced; and
the controller ranks the sets of row sums to generate a ranking of the plurality of business drivers from Most Dominant to Least Dominant.

12. The apparatus of claim 11, wherein the controller combines the ranking of the plurality of business drivers from Least Influenced to Most Influenced and the ranking of the plurality of business drivers from Most Dominant to Least Dominant to generate a ranking of the plurality of business drivers from Most Dominant/Least Influenced to Least Dominant/Most Influenced.

13. The apparatus of claim 12, wherein the controller multiplies the ranking of the plurality of business drivers from Least Influenced to Most Influenced and the ranking of the plurality of business drivers from Most Dominant to Least Dominant.

14. A method for evaluating influence interrelationships among a plurality of business drivers, each influence interrelationship indicating a change in one driver of the plurality of business drivers resulting from a change in another driver of the plurality of business drivers, the method comprising:
generating, via a controller, an interrelationship matrix that quantifies the influence interrelationships among the plurality of business drivers;
ranking, via the controller, the quantified influence interrelationships included in the interrelationship matrix to yield influence rankings,
summing, via the controller, the influence rankings;
ranking, via the controller, the plurality of business drivers based on the summed influence rankings to yield business driver rankings; and
outputting, via the controller, the business driver rankings.

15. A computer-readable storage device storing a program for evaluating influence interrelationships among a plurality of business drivers, each influence interrelationship indicating a change in one driver of the plurality of business drivers resulting from a change in another driver of the plurality of business drivers, the program comprising:
instructions for generating, via a controller, an interrelationship matrix that quantifies the influence interrelationships among the plurality of business drivers;
instructions for ranking, via the controller, the quantified influence interrelationships included in the interrelationship matrix to yield influence rankings:
instructions for summing, via the controller, the influence rankings;
instructions for ranking, via the controller, the plurality of business drivers based on the summed influence rankings to yield business driver rankings; and
instructions for outputting, via the controller, the business driver rankings.

16. An apparatus configured to evaluate influence interrelationships among a plurality of business drivers, each influence interrelationship indicating a change in one driver of the plurality of business drivers resulting from a change in another driver of the plurality of business drivers, the apparatus comprising:
matrix creation means for generating an interrelationship matrix that quantifies the influence interrelationships among the plurality of business drivers;
influence ranking means for ranking the quantified influence interrelationships included in the interrelationship matrix to yield influence rankings;
summation means for summing the influence rankings;
business driver ranking means for ranking the plurality of business drivers based on the summed influence rankings to yield business driver rankings; and
output means for outputting the business driver rankings.
